(19) United States
(12) Patent Application Publication
(10) Pub. No.: US 2010/0116447 A1
(43) Pub. Date: May 13, 2010

(54) BLIND FOR A WINDOW

(76) Inventor: Lavinia Caroline Thompson, South Staffs (GB)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/312,530

(22) PCT Filed: Nov. 14, 2007
(86) PCT No.: PCT/GB2007/004353

§ 371 Date: Dec. 23, 2009

(30) Foreign Application Priority Data
Nov. 14, 2006 (GB) 0622673.2

(51) Int. Cl. E06B 9/24; F16B 47/00

(52) U.S. Cl. 160/368.1; 248/206.3

(57) ABSTRACT

A black out blind (1) for a window which comprises a sheet of pliable material (4) and suction attachment means (3) for releasably attaching the sheet of material to a window or support member.

The present invention relates to a blind for a window. More specifically, the invention relates to a temporary black out blind which can be fitted and taken down as and when required.

It is often desirable to create a dark environment to assist young children and babies to fall asleep. This is particularly the case during daylight hours when daylight can make it difficult for children and babies to settle. It is particularly desirable to have a blackout blind to block out light in surroundings unfamiliar to the child or baby so that they may settle down to sleep more easily. Since children and babies may take naps during the day when they are not in their homes, the supervising adult may try to create a suitable sleeping environment by blocking out daylight from the location in which they are in, be it for example, a room or vehicle.

A known method for creating a makeshift blind involves the hanging or placing of large pieces of fabric, such as towels or blankets across a window by whatever means is available. This can cause problems if there is no curtain rail or other support member close to the window from which the fabric may be hung, attached to or propped up against. Even if a curtain rail or support member is present, it is inevitable that the fabric cannot be fitted and secured close around all the edges of the window. This means that light can pass through the edges of the fabric into the room or vehicle. Further, depending upon the size of the window the piece of fabric to hand may not be large enough to cover the whole window and further pieces may be needed. The joining together or overlapping of two or more pieces of fabric across the window may be problematic and may lead to gaps between the fabrics which is not desirable. Further still, since the makeshift blind consists of a fabric or fabrics which are not intended to be blinds, the fabric may not be suitable for blocking out the sunlight and may allow the light to penetrate. Even if the material of the makeshift blind is suitable for blocking out light, the material is often too heavy for it to be easily secured to a window.

There are rolled blinds on the market which comprise a roller and a length of blind material. The rollers of these devices are provided with releasable attachment means for the temporary attachment to a window or support member. The disadvantage of these devices is that the size of the roller and the width of the blind material cannot be adjusted to fit the width of the window. Therefore, if the roller is smaller than the width of the window, the window will not be fully covered by the blind material. Further, this type of blind does not account for the various shapes of windows which are found in buildings and vehicles and therefore may not cover all of the window. Further still, the blind material is usually stiff to allow it to be rolled. This means that, unless it is the correct size for the window it is difficult for it to be fitted, shaped or secured closely to the sides of the window.

There are also known shade devices for use in cars which may comprise attachment means for directly attaching a shade to a window. There are also shade devices for use with car windscreens which are propped up against the windscreen by the steering wheel and dash board. Both types of shades come in set sizes and do not usually correspond to the exact dimensions of the window concerned. They therefore provide only a partial shade from the light outside, rather than a total blackout. Further, they are fairly rigid and so cannot be moulded or otherwise shaped to the exact shape of the window which means they cannot be fitted and secured to the edges of the window. This means that light can pass through the edges of the window into the car.

It is therefore an object of the present invention to provide a temporary blind which mitigates or overcomes the problems associated with the aforementioned blind and shade devices.

According to one aspect of the invention there is provided a blind for a window comprising a sheet of flexible material and attachment means for releasably attaching the sheet of material to a window or support member wherein said attachment means is releasably attachable to the sheet of material.

According to a further aspect of the invention there is provided a blind for a window comprising a sheet of pliable material and suction attachment means for releasably attaching the sheet of material to a window or support member. By pliable material it is meant that the material is sufficiently flexible to be tucked and/or folded to cover windows of various shapes and sizes so as to prevent light passing through the window.

Preferably, the sheet of material is of a rectangular form. Preferably, the sheet comprises a microfibre material, such as a nylon or polyester material. More preferably, the sheet comprises a polyurethane coating. The polyurethane coating preferably comprises a black pigment. Such a material is lightweight, pliable and opaque.

Preferably, the suction attachment means is releasably attached to the material. Preferably, the suction attachment means comprise suction pads. Preferably, a plurality of suction pads are arranged along at least a part of a border of the sheet of material. The sheet can then be fitted to window by applying pressure to the suction pads. More suction pads can be attached to the sheet of material as is necessary to enable the material to be fitted along, or over all edges of the window. Preferably, the material is provided with eyelets for attaching the suction attachment means to the material. The eyelets are preferably arranged along the border of the sheet of material. When attaching the blind to a window, the user can decide which eyelets are to be fitted with suction pads to best cover the window. More preferably the eyelets comprise a metal. More preferably still the eyelets are located in a hem of the material.

The material is preferably provided with an adjustable means for gathering and securing the material of the blind. This allows the user to gather or fold and secure any material of the blind which is not being used to cover the window.

More preferably, at least a part of the border is provided with a least one adjustable means. The adjustable means preferably comprises a length of webbing. Preferably at least a part of the webbing is located in at least one hem. More preferably the webbing is provided with a series of apertures. More preferably still the sheet of material is provided with a fastening means to which the adjustable means may be fastened. Preferably, the fastening means comprises a button or a toggle.

The blind may further be provided with at least one hook to enable at least a portion of the blind to be gathered and secured.

The invention will now be described, by way of example only with reference to the following figures, in which:

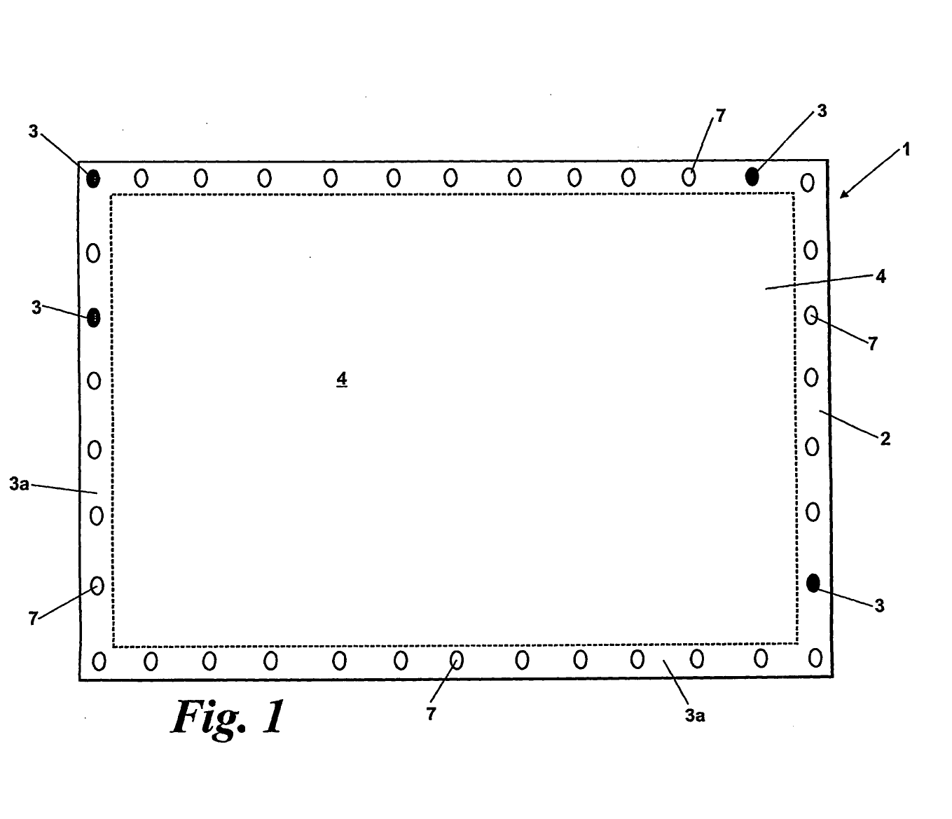

FIG. 1 is a plan view of a blind according to the invention,

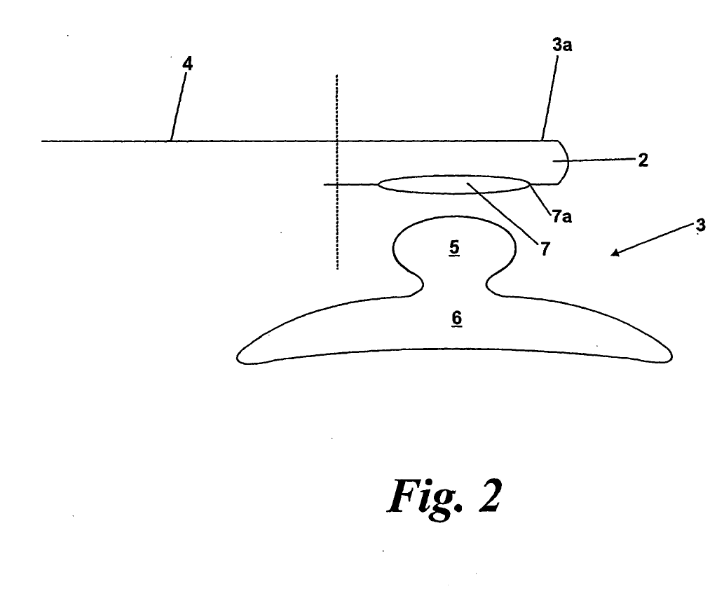

FIG. 2 is a cross sectional view of the attachment means used for attaching the blind,

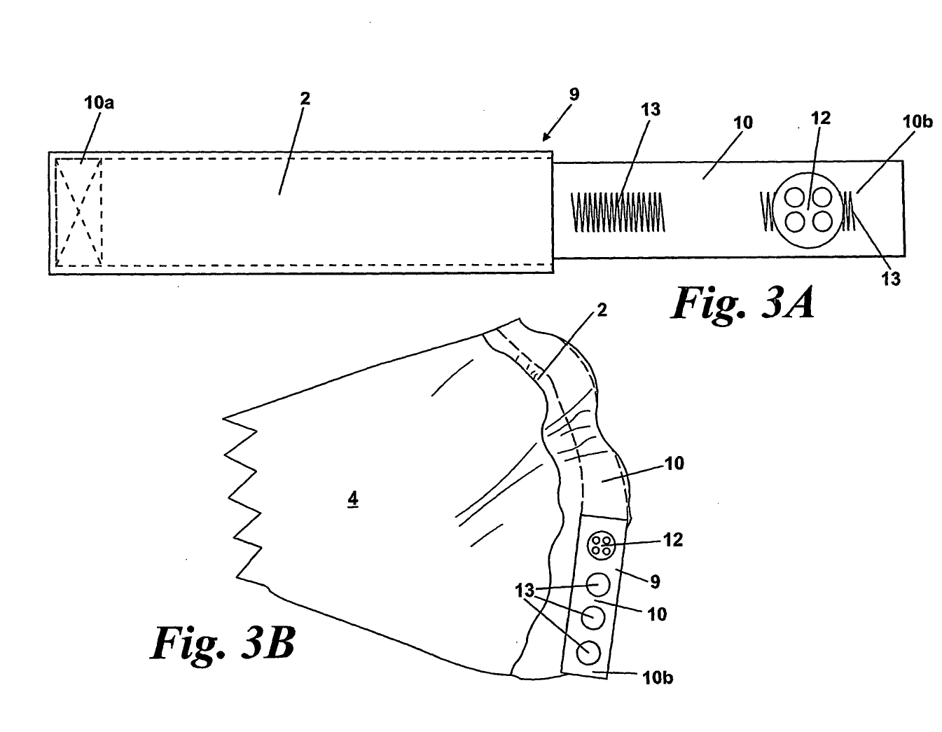

FIG. 3a is a plan view of an adjustable means used on the blind, and

FIG. 3b is a perspective view of the blind fitted with the adjustable means.

FIG. 1 shows a plan view of a blackout blind 1 for a window. The blind is a travel blind, by which it is meant that it is a temporary blind which can be carried and fitted and taken down as and when required. The surface shown in FIG. 1 is the surface which faces the window when fitted. The blind 1 comprises a rectangular sheet of material 4 which is flexible, inelastic, lightweight, and of a sufficient density to restrict the passage of light through it, for example, a microfibre material, such as, a nylon or polyester material with a polyurethane coating. Such a material is manufactured from a base microfibre material which is coated with a polyurethane coating comprising a black pigment. Such a material is substantially resistant to creasing. This has the advantage that when the sheet of material is fitted to a window it hangs relatively straight and is substantially free of creases even if it is has been packed and compacted for storage purposes. The sheet when fitted to a window therefore hangs neatly. The material 4 can be lined with a further piece of material, such as one containing aluminium to reflect the sunlight, or one suitable to restrict the loss of heat through the window. The surface of the material 4 which faces away from the window when fitted (not shown) may be patterned or decorated with a design so as to be aesthetically pleasing when viewed from within a room or vehicle.

The material 4 is folded over and secured along each side to form a hem 2 which constitutes a border 3a of the sheet. A plurality of eyelets 7 are arranged in a spaced relationship along the border 3a as shown in FIG. 1. Suction pads 3 may be attached to some or all of the eyelets 7 as required for fitting the material to, or over the window. It is possible that only part of the border is provided with eyelets, however, this will mean that the choice of positioning of the suction pads on the material is restricted than with the arrangement of eyelets shown in FIG. 1. As a consequence, it may be more time consuming for the user to fit the blind to the window. Further, it may mean that the material is not optimally fitted to, or over the window.

The blind may be of any dimension or shape, although typically, it will be rectangular having dimensions of a length of 2 m and a width of 1.3 m. Since the blind comprises a sheet of flexible material 4, the material can be pushed upto, tucked or folded into, or positioned over the edges of the window to substantially block out all light which passes through the window. By having a plurality of suction pads 3 which may be releasably attached to various positions on the border of the sheet of material, the material can be fitted to, or over the window in the desired position. This means the material can be positioned and fitted over the window to block out as much light as possible. Even if the window has an obstacle, such as piece of framework, the material can be positioned and secured around it so as to prevent light from around the obstacle passing through the material 4.

FIG. 2 shows a cross sectional view of one of the suction pads 3. The suction pad is made of a polymeric material, for example a polyurethane material. It comprises a bulbous part 5 which is releasably attachable to the eyelet 7 in the material 4 and a suction cup 6 which may be pressed against the window or other support member to attach the material to, or over the window. The eyelet 7 is positioned within the hem 2 of the material 4 and has a similar size to the bulbous part 5 of the suction pad so that when the suction pad is pushed into the eyelet it is held firmly in place. The suction pad is removed from the material by pulling it away from the eyelet. The eyelet comprises a ring made of a rubber or metallic material. An aperture 7a is made in one layer of the hem so that the eyelet is only accessible from one side of the material. This means that the other layer of the hem covers the aperture and prevents the passage of light through the aperture when there is no suction pad 6 in place.

An alternative means of releasably attaching the suction pad 3 to the sheet 4 is by using a Velcro means. A piece of Velcro is secured to the bulbous part 5 of the pad 3 and a piece is secured to the hem 2 in place of the eyelet. The pad can then be releasably attached to the material 4.

FIG. 3a shows a plan view of an adjuster 9. FIG. 3b shows a perspective view of the adjuster 9 attached to the blind 1. The adjuster 9 comprises a strip of webbing 10 having a series of apertures 13. The webbing is threaded through and along the hem 2 of one of the borders 3a of the material 4. One end 10a is fixed to the hem 2 by stitching or other means and the other end 10b may be attached to a button, or toggle 12 located on the border 3a. By pulling the webbing 10 and gathering the material 4 along the webbing, the length or width of the sheet of material may be shortened. The webbing 10 is indicated in the hem 2 in FIG. 3b by the broken lines. The amount of material 4 that is gathered may be varied depending on which of the apertures 13 is secured to the button or toggle 12. An adjuster 9 may be located in any one or more of the hems. Where an adjuster is provided in all four hems, a button or toggle 12 is attached on each of the corners of the border 3a of the sheet of material 4 for securing an end 10b of the webbing.

The blind 1 may be compacted and carried in a pouch or bag. When required, the blind 1 is taken out of the pouch and fitted to a window or support member using the suction pads 3. For a regular shaped window, a corner of the blind can be affixed to an upper corner of the window. An edge of the blind can then be taken across the top edge of the window and secured to the window using the appropriate suction pad or pads 3. If the window has a piece of framework or other obstacle, the blind can be folded or moulded around the framework or obstacle and secured around it as necessary using the suction pads 3. This ensures the blind is fitted close to the edges of the window. If the window is not as wide as the material, the adjuster 9 can be used to shorten the width of the material so that the corner of the blind 1 corresponds to the other upper corner of the window. Alternatively, the adjuster 9 does not have to be used and the excess material to the side of the window can be simply pushed and tucked away from the side of the window. It is therefore not necessary that all suction pads 3 along a given side of the border 3a are used. The remaining edges of the blind 1 can be attached to the window by using the suctions 3 and adjuster 9 where necessary.

The blind may be carried and stored with all the eyelets 7 fitted with suction pads 3. Alternatively, the suction pads may fitted to the blind 1, as necessary to fit the blind to a window.

To remove the blind, the suction pads are simply pulled away from window or support member and the blind rolled or folded ready for storage in a bag or pouch.

The blind has the advantage that it is lightweight and compactable and quick and easy to put up and take down. Moreover, because the material is flexible it can be fitted to cover windows of varying shapes and sizes and can be fitted and secured close to the edges of the window to ensure that as much light as possible is blocked out.

It is to be understood that the scope of the present invention is not to be limited by the embodiment shown in the drawings. In particular, the blind may be made in a wide range of sizes. Moreover, the invention includes any novel and inventive feature disclosed herein, either alone, or in combination with any one or more such features.

1. A black out blind for a window comprising a sheet of pliable material and suction attachment means for releasably attaching the sheet of material to a window support member, wherein the sheet of material is provided with at least three eyelets arranged along a border of the sheet of material for attaching the suction attachment means thereto.

2. A black out blind as claimed in claim 1 wherein the sheet of material is of a rectangular form.

3. A black out blind as claimed in claim 1 wherein the sheet of material comprises a microfibre material.

4. A black out blind as claimed in claim 1 wherein the sheet of material comprises a polyurethane coating.

5. A black out blind as claimed in claim 4 wherein the polyurethane coating comprises a black pigment.

6. A black out blind as claimed in claim 1 wherein the suction attachment means comprises suction pads.

7. A black out blind as claimed in claim 1 wherein a plurality of suction pads are arranged along at least a part of a border of the sheet of material.

8. (canceled)

9. A black out blind as claimed in claim 1 wherein the eyelets are located in a hem of the material.

10. A black out blind as claimed in claim 1 wherein the material is provided with an adjustable means for gathering and securing the material of the blind.

11. A black out blind as claimed in claim 10 wherein at least a part of a border of the material is provided with at least one adjustable means.

12. A black out blind as claimed in claim 10 wherein the adjustable means comprises a length of webbing.)

13. A black out blind as claimed in claim 12 wherein at least a part of the webbing is located in a hem of the material.

14. A black out blind as claimed in claim 10 wherein the adjustable means is provided with a series of apertures.

15. A black out blind as claimed in claim 10 wherein the material is provided with a fastening means to which the adjustable means may be fastened.

16. (canceled)

17. A black out blind as claimed in claim 1 wherein the blind is further provided with at least one hook to hold the blind in a folded position.

18. (canceled)
